(19) United States
(12) Patent Application Publication
(10) Pub. No.: US 2024/0178969 A1
(43) Pub. Date: May 30, 2024

(54) SOUNDING REFERENCE SIGNAL TRANSMISSIONS FOR MASSIVE UPLINK TRANSMITTERS

(71) Applicant: ZTE Corporation, Shenzhen (CN)

(72) Inventors: Bo GAO, Shenzhen (CN); Zhaohua LU, Shenzhen (CN); Ke YAO, Shenzhen (CN); Minqiang ZOU, Shenzhen (CN); Xiaolong GUO, Shenzhen (CN)

(21) Appl. No.: 18/521,837

(22) Filed: Nov. 28, 2023

Related U.S. Application Data
(63) Continuation of application No. PCT/CN2022/088319, filed on Apr. 21, 2022.

(51) Int. Cl. H04L 5/00; H04L 27/26; H04W 72/1268

(52) U.S. Cl. CPC H04L 5/0051; H04L 27/2605; H04W 72/1268

(57) ABSTRACT

Methods, systems, and devices for sounding reference signal (SRS) transmission for massive uplink (UL) transmitters are described. An example method for wireless communication includes determining, by a wireless device, one or more sounding reference signal (SRS) resources, and performing, using one or more SRS ports in the one or more SRS resources, an SRS transmission to a network node. Another example method for wireless communication includes receiving, by a network node from a wireless device, a sounding reference signal (SRS) transmission over one or more SRS resources, wherein the wireless device is configured to determine the one or more SRS resources and perform the SRS transmission using one or more SRS ports in the one or more SRS resources.

### CROSS-REFERENCE TO RELATED APPLICATION

This application is a continuation and claims priority to International Application No. PCT/CN2022/088319, filed on Apr. 21, 2022, the disclosure of which is hereby incorporated by reference herein in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for sounding reference signal (SRS) transmission for massive uplink (UL) transmitters, which advantageously supports the uplink throughput increase associated with emerging technologies and implementations, e.g., Customer Premises Equipment (CPE), Fixed Wireless Access (FWA), vehicular devices, and industrial devices. In an example, the described embodiments support more SRS ports for a single Physical Uplink Shared Channel (PUSCH) transmission by increasing the number of SRS ports in a single SRS resource or providing SRS resource combinations for more ports. In another example, for non-codebook based PUSCH transmissions, the association between SRS resources and one or more channel state information (CSI)-reference signal (RS) for facilitating the UL precoding on the User Equipment (UE) side is described. In yet another example, for SRS antenna switching, allocating massive SRS ports across several SRS resources or sets for massive UL transmission cases is described. In yet another example, solutions that leverage the assistance of a DL RS for channel and interference measurement to support SRS port hopping and beamformed SRS for coherent joint transmission (C-JT) are described.

In an example, aspect, a method for wireless communication is described. The method includes determining, by a wireless device, one or more sounding reference signal (SRS) resources, and performing, using one or more SRS ports in the one or more SRS resources, an SRS transmission to a network node.

In another example aspect, a method for wireless communication is described. The method includes receiving, by a network node from a wireless device, a sounding reference signal (SRS) transmission over one or more SRS resources, wherein the wireless device is configured to determine the one or more SRS resources and perform the SRS transmission using one or more SRS ports in the one or more SRS resources.

In yet another example aspect, the above-described methods are embodied in the form of processor-executable code and stored in a non-transitory computer-readable storage medium. The code included in the computer readable storage medium when executed by a processor, causes the processor to implement the methods described in this patent document.

In yet another example embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIGS. 1A-1D show examples of 8-Tx UE antenna architectures.

FIG. 2 shows an example framework for SRS transmission for massive UL transmitters in accordance with the presently disclosed technology.

FIG. 3 shows an example of a Medium Access Control (MAC)-Control Element (CE) for combining one or more SRS resources for an SRS Resource Indicator (SRI) codepoint.

FIG. 4 shows an example diagram for transmitting more than one SRS resource.

FIG. 5 shows example cases for supporting 8-Tx SRS ports.

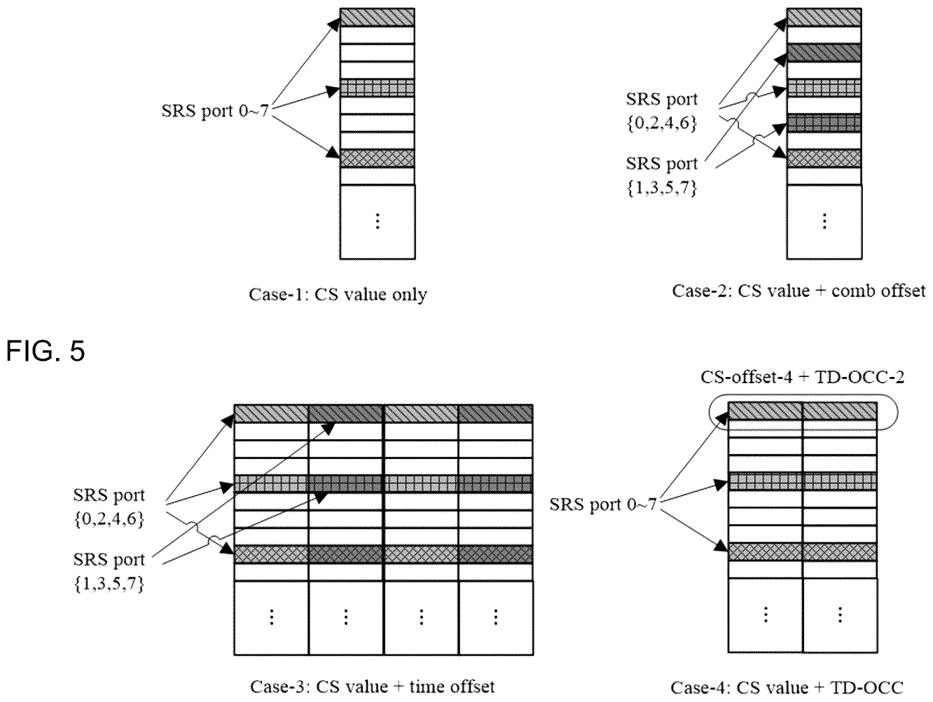

FIG. 6 shows a flowchart for an example method for wireless communication.

FIG. 7 shows a flowchart for another example method for wireless communication.

FIG. 8 shows an example block diagram of a hardware platform that may be a part of a network device or a communication device.

FIG. 9 shows an example of wireless communication including a base station (BS) and user equipment (UE) based on some implementations of the disclosed technology.

### DETAILED DESCRIPTION

In Fifth Generation (5G) New Radio (NR), time division duplexing (TDD)-based networking is emerging as the preferred implementation because the wide or ultra-wide spectrum requirement results in frequency division duplexing (FDD)-based networking as infeasible. In these systems, channel reciprocity is leveraged and thus, SRS design is essential for wireless channel estimation for both downlink (DL) and uplink (UL) transmissions. With the increase of user equipment (UE) UL transmitters, enhancing SRS transmissions to facilitate UL massive multiple-input multiple-output (MIMO) requirements (e.g., to support UL 8-transmitters or more) is required for current and developing wireless communication systems.

In order to support UL massive MIMO/transmitters, the current implementations for SRS port and resource configuration and/or mapping need to be improved and flexible SRS-beamformed schemes (e.g., for coherent joint transmission (C-JT) need to be developed.

Embodiments of the disclosed technology provide, inter alia, the following technical solutions:
(1) For accommodating PUSCH codebook and non-codebook transmission in massive UL transmitters, for a single PUSCH transmission, embodiments that support more SRS ports in a single SRS resource or combine more than one resources are described. For example, the mapping between SRS port and sequence/resource (e.g., resource element (RE)) are considered when supporting more SRS ports in a single resource, and when supporting the combination of more than one resource, configuration enhancement and the corresponding rules are described.
(2) In order to assist DL precoding via exploiting channel reciprocity, embodiments for SRS antenna switching in the massive UL transmitters are described. Compared to legacy SRS transmission schemes, the allocation of massive SRS ports across several SRS resources or SRS resource sets is considered.
(3) With the increase of UL transmitters, the UE can efficiently perform a high-resolution beamforming procedure compared with legacy UE implementations. In order to mitigate the UL interference and implicitly represent DL interference, embodiments for SRS port hopping and beamformed SRS (with assistance of DL reference signals, e.g., channel state information (CSI)-reference signal (RS), non-zero-power (NZP) CSI-RS for interference measurement, and CSI interference measurement (CSI-IM)) are described.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the document are not limited to 5G technology only, and may be used in wireless systems that implemented other protocols.

### 1 Sounding Reference Signal (SRS) Overview

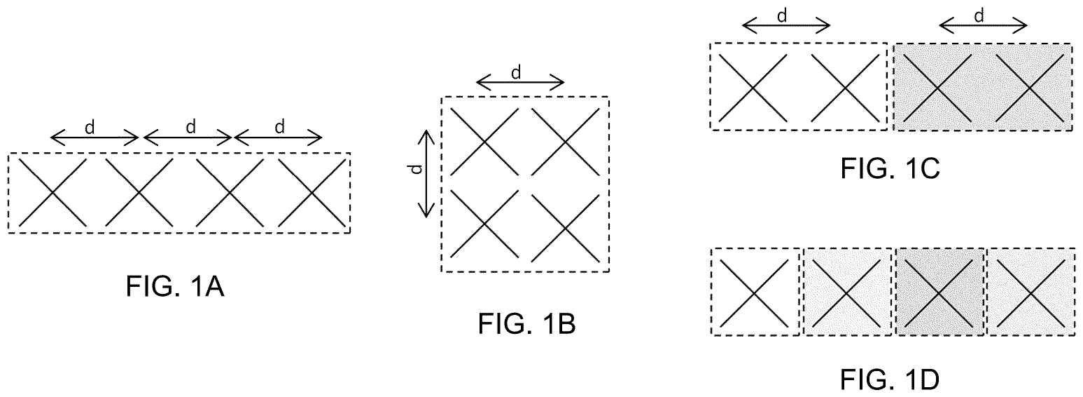

With the increase of UL transmitters (e.g., using the example User Equipment (UE) antenna architectures shown in FIGS. 1A-1D with FIGS. 1A and 1B showing fully coherent cases with different N1/N2 configurations and FIGS. 1C and 1D showing partially coherent cases), embodiments for SRS enhancement for accommodating the corresponding requirement for UL data transmission (e.g., codebook and non-codebook based transmission, antenna switching, and interference randomization (e.g., for C-JT)) are described in this document. For example, in LTE, there is a single legacy UL transmitter in a UE, but in 5G-NR, there may be two transmitters in a UE. Furthermore, in 5G-advance or 6G systems, more and more UE UL transmitters may be deployed, especially for customer premise equipment (CPE), fixed wireless access (FWA), vehicular devices, and industrial devices.

In some embodiments, and for a legacy SRS configuration, an SRS resource is configured by a Radio Resource Control (RRC) and includes:
Nₐₚ^{SRS}∈{1,2,4} antenna ports {pᵢ}ᵢ₌₀^{N}^{ₐₚ}^{^{SRS}}⁻¹, where Nₐₚ^{SRS} denotes the number of antenna ports,
N_{symb}^{SRS}∈{1,2,4,8,12} denotes that number of consecutive OFDM symbols,
l₀, the starting position in the time domain given by l₀=N_{symb}^{slot}−1−l_{offset} where the offset l_{offset}∈{0,1, . . . ,13} counts symbols backwards from the end of the slot, and
k₀, the frequency-domain starting position of the sounding reference signal.

In this embodiments, the SRS sequence for an SRS resource may be generated according to the following:

$$\begin{matrix}{r}^{( {p}_{i} )} ( n , {l}^{′} ) = {r}_{u , v}^{( {a}_{i} , δ )} ( n ) \\ 0 \leq n \leq {M}_{sc , b}^{S R S} - 1 \\ {l}^{′} ∈ \{ 0 , 1 , … , {N}_{symb}^{SRS} - 1 \}\end{matrix}$$

Herein, M_{sc,b}^{SRS} denotes length of the sounding reference signal sequence, the sequence is given by M_{sc,b}^{SRS}=m_{SRS,b}N_{sc}^{RB}/(K_{TC}P_{F}), where m_{SRS,b} represents the bandwidth of SRS, b=B_{SRS} with B_{SRS}∈{0,1,2,3} is given by the field b-SRS configured by RRC.

For example, r_{u,v}^{(α,δ)} (n) is a type of sequence (e.g., defined in clause 5.2.2 in TS 38.211 or a ZC sequence), wherein:
δ=log₂(K_{TC}) and the transmission comb number K_{TC}∈{2,4,8} is contained in the higher-layer parameter transmissionComb.
The cyclic shift αᵢ for antenna port pᵢ is given as

$${α}_{i} = 2 π \frac{{n}_{S R S}^{cs , i}}{{n}_{S R S}^{cs , max}}$$

$${n}_{S R S}^{cs , i} = \{ \begin{matrix}( {n}_{S R S}^{c s} + \frac{{n}_{S R S}^{cs , max} ⌊ ( {p}_{i} - 10 \; 00 ) / 2 ⌋}{{N}_{a p}^{S R S} / 2} ) mod {n}_{S R S}^{cs , max} & if {N}_{a p}^{S R S} = 4 and {n}_{S R S}^{cs , max} = 6 \\ ( {n}_{S R S}^{c s} + \frac{{n}_{S R S}^{cs , max} ( {p}_{i} - 1000 )}{{N}_{a p}^{S R S}} ) mod {n}_{S R S}^{cs , max} & otherwi s e\end{matrix} ,$$

where n_{SRS}^{cs}∈{0,1, . . . , n_{SRS}^{cs,max}−1} denotes the value of the corresponding cyclic shift, and the maximum number of cyclic shifts is given by n_{SRS}^{cs,max}.
The sequence group u=(ƒ_{gh}(n_{s,f′}^{u}, l′)+n_{ID}^{SRS}) mod 30 and the sequence number v are also configured by RRC.

Herein, n_{ID}^{SRS} and n_{s,f}^{μ} denote the SRS sequence identity and the number of slots in a frame with subcarrier spacing configuration μ, respectively, and l′∈{0,1, . . . , N_{symb}^{SRS}−1} is the OFDM symbol number within the SRS resource. Furthermore,
if groupOrSequenceHopping equals ‘neither’, neither group, nor sequence hopping shall be used and

$$\begin{matrix}{f}_{g h} ( {n}_{s , f}^{μ} , {l}^{′} ) = 0 \\ v = 0\end{matrix}$$

if groupOrSequenceHopping equals ‘groupHopping’, group hopping but not sequence hopping shall be used and

$$\begin{matrix}{f}_{g h} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 \\ v = 0\end{matrix}$$

where c(i) denotes the pseudo-random sequence and shall be initialized with cᵢₙᵢₜ=n_{ID}^{SRS} at the beginning of each radio frame.
if groupOrSequenceHopping equals ‘sequenceHopping’, sequence hopping but not group hopping shall be used and

$$\begin{matrix}{f}_{g h} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{s c , b}^{S R S} \geq 6 {N}_{sc}^{R B} \\ 0 & otherwise\end{matrix}\end{matrix}$$

where c(i) denotes the pseudo-random sequence and shall be initialized with cᵢₙᵢₜ=n_{ID}^{SRS} at the beginning of each radio frame.
if groupOrSequenceHopping equals ‘sequenceHopping’, sequence hopping but not group hopping shall be used and

$$\begin{matrix}{f}_{g h} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{s c , b}^{S R S} \geq 6 {N}_{sc}^{R B} \\ 0 & otherwise\end{matrix}\end{matrix}$$

where c(i) denotes the pseudo-random sequence and shall be initialized with cᵢₙᵢₜ=n_{ID}^{SRS} at the beginning of each radio frame.

In some embodiments, and when SRS is transmitted on a given SRS resource, the sequence r^{(p}^{ᵢ}⁾(n, l′) for each OFDM symbol l′ and for each of the antenna ports of the SRS resource shall be multiplied with the amplitude scaling factor β_{SRS} in order to conform to the transmit power and mapped in sequence starting with r^{(p}^{ᵢ}⁾(0, l′) to resource elements (k, l) in a slot for each of the antenna ports pᵢ according to

$${a}_{{K}_{T C} {k}^{′} + {k}_{0}^{( {p}_{i} )} , {l}^{′} + {l}_{0}}^{( {p}_{i} )} = \{ \begin{matrix}\frac{1}{\sqrt{{N}_{a p}}} {β}_{SRS} {r}^{( {p}_{i} )} ( {k}^{′} , {l}^{′} ) & {k}^{′} = 0 , 1 , … , {M}_{sc , b}^{S R S} - 1 {l}^{′} = 0 , 1 , … , {N}_{s y m b}^{SRS} - 1 \\ 0 & otherwise\end{matrix}$$

In some embodiments, and ignoring SRS for positioning, the frequency-domain starting position k₀^{(p}^{ᵢ}⁾ is defined by

$${k}_{0}^{( {p}_{i} )} = {\overline{k}}_{0}^{( {p}_{i} )} + {n}_{offset}^{F H} + {n}_{offset}^{R P F S} .$$

where

$$\begin{matrix}{\overline{k}}_{0}^{( {p}_{i} )} = {n}_{shift} {N}_{sc}^{RB} + {k}_{TC}^{( {p}_{i} )} mod {K}_{TC} \\ {k}_{TC}^{( {p}_{i} )} = \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} ∈ \{ {n}_{SRS}^{cs , max} / 2 , … , {n}_{SRS}^{cs , max} - 1 \} \\ {\overline{k}}_{TC} & otherwise\end{matrix} \\ {n}_{offset}^{FH} = {\sum }_{b = 0}^{{B}_{SRS}} {K}_{TC} {M}_{sc , b}^{SRS} {n}_{b} \\ {n}_{offset}^{RPFS} = {N}_{sc}^{RB} {m}_{SRS , {B}_{SRS}} ( ( {k}_{F} + {k}_{hop} ) mod {P}_{F} ) / {P}_{F}\end{matrix}$$

Herein, k_{F}∈{0,1, . . . , P_{F}−1} is defined by the higher-layer parameter StartRBIndex if configured, otherwise k_{F}=0, and kₕₒₚ is defined using Table-1 with

$$\begin{matrix}{\overline{k}}_{hop} = ⌊ \frac{{n}_{SRS}}{{\prod }_{{b}^{′} = {b}_{hop}}^{{B}_{SRS}} {N}_{{b}^{′}}} ⌋ mod {P}_{F} \\ {N}_{{b}_{hop}} = 1\end{matrix}$$

TABLE 1
kₕₒₚ as a function of k̅ₕₒₚ

| | kₕₒₚ | | |
|---|---|---|---|
| k̅ₕₒₚ | P_{F} = 1 | P_{F} = 2 | P_{F} = 4 |
| 0 | 0 | 0 | 0 |
| 1 | — | 1 | 2 |
| 2 | — | — | 1 |
| 3 | — | — | 3 |

In some embodiments, the frequency domain shift value n_{shift} adjusts the SRS allocation with respect to the reference point grid and is contained in the higher-layer parameter freqDomainShift. The transmission comb offset k̅_{TC}∈{0,1, . . . , K_{TC}−1} is contained in a higher-layer parameter and n_{b} is a frequency position index.

In some embodiments, frequency hopping of the sounding reference signal is configured by the parameter bₕₒₚ∈{0,1,2,3}, given by the field b-hop contained in the higher-layer parameter freqHopping if configured, otherwise bₕₒₚ=0.

If bₕₒₚ≥ B_{SRS}, frequency hopping is disabled and the frequency position index np remains constant (unless re-configured) and is defined by

$${n}_{b} = ⌊ 4 {n}_{R R C} / {m}_{S R S , b} ⌋ mod {N}_{b}$$

for all N_{symb}^{SRS} OFDM symbols of the SRS resource.

Herein, n_{RRC} is given by the higher-layer parameter freqDomainPosition.

If bₕₒₚ<B_{SRS}, frequency hopping is enabled and the frequency position indices n_{b} are defined by

$${n}_{b} = \{ \begin{matrix}⌊ 4 {n}_{RRC} / {m}_{SRS , b} ⌋ mod {N}_{b} & b \leq {b}_{hop} \\ ( {F}_{b} ( {n}_{SRS} ) + ⌊ 4 {n}_{RRC} / {m}_{SRS , b} ⌋ ) mod {N}_{b} & otherwise\end{matrix}$$

where N_{b} is given by Table 6.4.1.4.3-1,

$${F}_{b} ( {n}_{SRS} ) = \{ \begin{matrix}( {N}_{b} / 2 ) ⌊ \frac{{n}_{SRS} mod {\prod }_{{b}^{′} = {b}_{h o p}}^{b} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋ & if {N}_{b} even \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{b} odd\end{matrix}$$

and N_{b}_{ₕₒₚ}=1 regardless of the value of N_{b}.

Herein, n_{SRS} counts the number of SRS transmissions.

In the case of an SRS resource being configured as aperiodic by the higher-layer parameter resourceType, it is given by n_{SRS}=└l′/R┘ within the slot in which the N_{symb}^{SRS} symbol SRS resource is transmitted. The quantity R≤ N_{symb}^{SRS} is the repetition factor given by the field repetition Factor if configured, otherwise R=N_{symb}^{SRS}.

In the case of an SRS resource being configured as periodic or semi-persistent by the higher-layer parameter resourceType, the SRS counter is given by

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

for slots that satisfy (Nₛₗₒₜ^{frame,μ}n_{ƒ}+n_{s,f}^{μ}−T_{offset}) mod T_{SRS}=0, where T_{SRS} and T_{offset} denotes periodicity in slots and slot offset, respectively.

### 2 Definitions and Terms Related to the Disclosed Technology

As referred to herein, a “beam state” is equivalent to a quasi-co-location (QCL) state, a transmission configuration indicator (TCI) state, a spatial relation (or spatial relation information), a reference signal (RS), a spatial filter, or pre-coding. In some embodiments, a “beam state” is also referred to as a “beam”. In some embodiments a “Tx beam” is equivalent to a QCL state, a TCI state, a spatial relation state, a DL reference signal, a UL reference signal, a Tx spatial filter, or Tx precoding. In some embodiments, an “Rx beam” is equivalent to a QCL state, TCI state, spatial relation state, spatial filter, Rx spatial filter or Rx precoding.

As referred to herein, a “beam ID” is equivalent to a QCL state index, a TCI state index, a spatial relation state index, a reference signal index, a spatial filter index, or a precoding index. In some embodiments, the spatial filter (or spatial-domain filter) can be either a UE-side spatial filter or a gNB-side spatial filter.

As referred to herein, “spatial relation information” includes one or more reference RSs, which is used to represent the same or quasi-co “spatial relation” between the targeted “RS or channel” and the one or more reference RSs. In some embodiments, “spatial relation” means a beam, a spatial parameter, or a spatial domain filter.

As referred to herein, “QCL state” includes one or more reference RSs and their corresponding QCL type parameters, where the QCL type parameters include at least one of the following aspects, or their combinations: [1] Doppler spread, [2] Doppler shift, [3] delay spread, [4] average delay, [5] average gain, and [6] Spatial parameter (or spatial Rx parameter).

As referred to herein, “TCI state” is equivalent to “QCL state”. In some embodiments, the different types of QCL states are defined as:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

As referred to herein, a reference signal (RS) includes a channel state information reference signal (CSI-RS), a synchronization signal block (SSB) (or SS/PBCH), a demodulation reference signal (DMRS), a sounding reference signal (SRS), and a physical random access channel (PRACH). In some embodiments, the RS includes at least DL reference signaling and UL reference signaling. In some embodiments, DL reference signaling includes a CSI-RS, an SSB, or a DMRS (e.g., DL DMRS). In some embodiments, UL reference signaling includes an SRS, a DMRS (e.g., UL DMRS), and a PRACH.

As referred to herein, an “uplink (UL) signal” includes a Physical Uplink Control Channel (PUCCH), a PUSCH, or an SRS.

As referred to herein, a “downlink (DL) signal” includes a Physical Downlink Control Channel (PDCCH), a Physical Downlink Shared Channel (PDSCH), or a CSI-RS. In some embodiments, the PDCCH is equivalent to a Downlink Control Information (DCI).

As referred to herein, a “time unit” can be a sub-symbol, a symbol, a slot, a subframe, a frame, or a transmission occasion.

As referred to herein, a power control parameter includes at least one of a pathloss RS, an open-loop parameter, or a closed loop index. In some embodiments, the power control parameter is equivalent to “UL power control parameter”. In some embodiments, the closed loop index is equivalent to a “power control adjustment state”. In some embodiments, the open-loop parameter includes at least one of a target power (P0) and/or a factor (α).

As referred to herein, a “port” is equivalent to an antenna port, a UE antenna port, or an SRS port. In some embodiments, an SRS port is equivalent to an antenna port, or a UE antenna port. In some embodiments, an antenna port is defined such that the channel over which a symbol on the antenna port is conveyed can be inferred from the channel over which another symbol on the same antenna port is conveyed.

As referred to herein, “antenna switching” or “SRS antenna switching” is equivalent to downlink (DL) channel state information (CSI) acquisition.

### 3 Examples of SRS Transmission Schemes Supporting Massive UL Transmitters

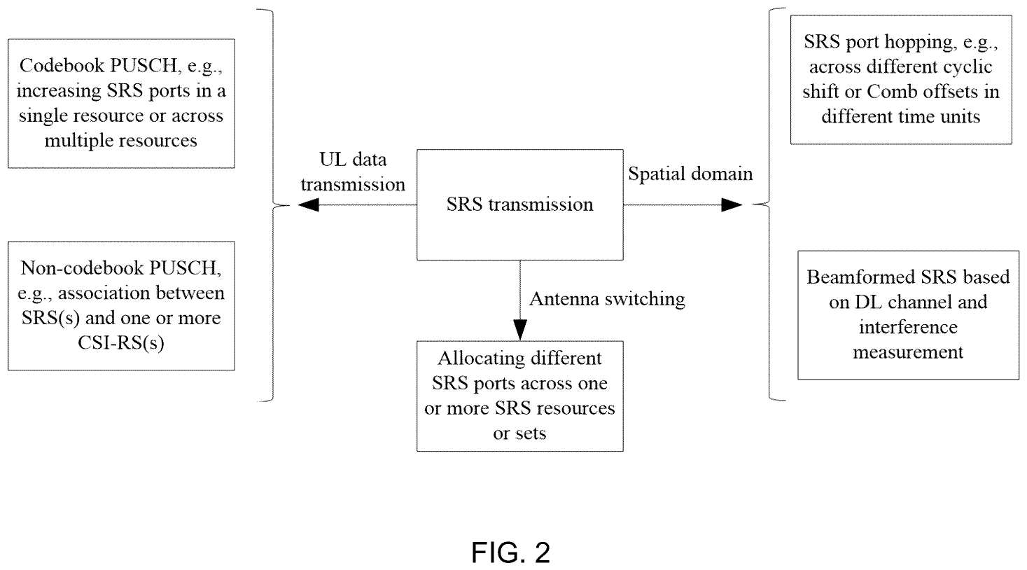

As shown in FIG. 2, embodiments of the disclosed technology provide, inter alia, the following technical solutions to massive UL transmitters:
(1) For UL data transmission, provide sufficient SRS ports for accommodating the UL transmission for both PUSCH codebook and non-codebook transmissions;
(2) For antenna switching, allocate massive SRS ports across several SRS resources or SRS resource sets, and specify the corresponding rules; and
(3) To mitigate cross-SRS interference for inter/intra-Transmission/Reception Point (TRP)/cell, provide interference randomization with SRS port hopping and beamformed SRS transmissions.

In some embodiments, a UE determines an SRS sequence and SRS related resource elements (e.g., physical resources in the frequency and time domain) based on one or more SRS configuration parameters, and then transmits the corresponding SRS.

In some embodiments, and for codebook transmissions for PUSCH, (i) the number of SRS ports in a single resource are increased to greater than 4 (e.g., to support up to 8 SRS ports for 8-TX UL operation), and each of the additional SRS ports is defined by a cyclic shift (CS), and (ii) more than one SRS resource is used to support additional SRS ports. In this latter case, the additional enhancement for the increased SRS ports in a single SRS resource may not be required. These embodiments are further detailed in Section 4.

In some embodiments, and for non-codebook transmissions for PUSCH, the CSI-RS can be associated with the SRS. For example, one or more CSI-RSs can be associated with SRS resource sets. For another example, two or more CSI-RSs can be applied to each or all SRS resources in a single set or different sets. These embodiments are further detailed in Section 5.

In some embodiments, and for SRS antenna switching, different SRS antenna ports are allocated across different SRS resources that can be in a single SRS resource set or from different SRS resource sets. These embodiments are further detailed in Section 6.

In some embodiments, and for SRS port hopping, SRS port related parameters, e.g., a different CS value or comb offset, are determined based on SRS related time units, e.g., n_SRS or SRS_ID. In some embodiments, SRS is enhanced to directly reflect DL interference spatial information (utilizing UL-DL reciprocity), and in terms of UL precoding or beam state, the SRS transmission is determined based on a non-zero-power (NZP) CSI-RS for interference measurement or a CSI-IM. These embodiments are further detailed in Section 7.

### 4 Examples of SRS for Codebook-Based PUSCH Transmissions

For codebook-based PUSCH transmissions, there typically is a one-to-one mapping between PUSCH ports and SRS ports, and the transmitter precoding matrix indicator (TPMI) provides the UL precoding information based on the measured SRS ports. For example, a codebook-based PUSCH transmission may correspond to a single SRS resource, which implies that the number of SRS ports in the single SRS resource increases to support the massive UL transmitter.

In some embodiments, the SRS port is based on a CS value and/or comb offset. In some examples, different ports in an 8-port SRS resource corresponds to different CS values and/or comb offsets. In other examples, the following cases are considered:
Case 1. The SRS port can be distinguished from other SRS ports in the resource based on only the CS value, and in this case, transmission comb number K_{TC}∈{2,4}. This implies that K_{TC}=8 is precluded; this is because the maximum number of CS values is 6, and the different SRS ports cannot be distinguished.
Case 2. The SRS port can be distinguished from other SRS ports in the resource based on both the CS value and the comb offset, and in this case, transmission comb number K_{TC}∈{2,4,8}. For 8-Tx UL operation, each of 8 ports in an SRS resource can be distinguished based on both 4 different CS values and 2 different comb offsets.
   For example, CS αᵢ for SRS port pᵢ is determined as:

$$\begin{matrix}{α}_{i} = 2 π \frac{{n}_{SRS}^{cs , i}}{{n}_{SRS}^{cs , max}} \\ {n}_{SRS}^{cs , i} = ( {n}_{SRS}^{c s} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max}\end{matrix}$$

In one case, Nₐₚ^{SRS}=8 and n_{SRS}^{cs,max}=6.
   In another case, Nₐₚ^{SRS}=8 and K_{TC}=8.
For example, CS αᵢ for SRS port pᵢ is determined as (pᵢ mod Nₐₚ^{SRS}) or (floor(pᵢ/2)), wherein Nₐₚ^{SRS} is a number of antenna ports.
For example, if a condition is satisfied, comb offset k_{TC}^{(p}^{ᵢ}⁾ for SRS port pᵢ is determined as:

$${k}_{T C}^{( {p}_{i} )} = \{ \begin{matrix}( {\overline{k}}_{T C} + {K}_{T C} / 2 ) mod {K}_{T C} & condition satisfied \\ {\overline{k}}_{T C} & otherwise\end{matrix}$$

In one case, the condition is Nₐₚ^{SRS}=8, pᵢ∈{1001, 1003, 1005,1007}, and n_{SRS}^{cs,max}=6.
   In another case, the condition is Nₐₚ^{SRS}=8, pᵢ∈{1001, 1003, 1005,1007}, and K_{TC}=8.
For example, comb offset k_{TC}^{(p}^{ᵢ}⁾ for SRS port pᵢ is determined as k̅_{TC} or (K̅_{TC}+K_{TC}/2) mod K_{TC}.
For example, the comb offset for an SRS port group in an SRS resource is configured by RRC or MAC-CE.
For example, one or more combination for CS value(s) and comb offset(s) for an SRS port group in an SRS resource are configured by RRC or MAC-CE.
Case 3. The SRS port can be distinguished from other SRS ports in the resource based on both the CS value and a time offset, and in this case, transmission comb number K_{TC}∈{2,4,8}. For 8-Tx UL operation, each of 8 ports in an SRS resource can be distinguished based on both 4 different CS values and 2 different time offsets.
For example, a time position l′ for SRS port pᵢ is determined as:

l′∈{1,3, . . . , N_{symb}^{SRS}−1−N_{symb}^{SRS} mod 2} if pᵢ∈{1001, 1003, 1005,1007}

l′∈{0,2, . . . , N_{symb}^{SRS}−1−(N_{symb}^{SRS}−1)mod 2} otherwise
In one case, Nₐₚ^{SRS}=8.
   For example, the time offset is determined based on the transmission comb number K_{TC}.
Case 4. The SRS port can be distinguished from other SRS ports in the resource based on both the CS value and an orthogonal cover code (OCC) parameter, and in this case, transmission comb number K_{TC}∈{2,4,8}.
   For example, for 8-Tx UL operation, each of 8 ports in an SRS resource can be distinguished based on both 4 different CS value and 2 different OCC parameters.
   For example, for 8-Tx UL operation, each of 8 ports in an SRS resource can be distinguished based on both 2 different CS value and 4 different OCC parameters.
   For example, the SRS port can be determined based on both the OCC parameter and the CS value, or both the OCC parameter and the comb offset, or the OCC parameter, the CS value and the comb offset.
   For example, SRS port can be determined based on both the OCC parameter and the CS value.

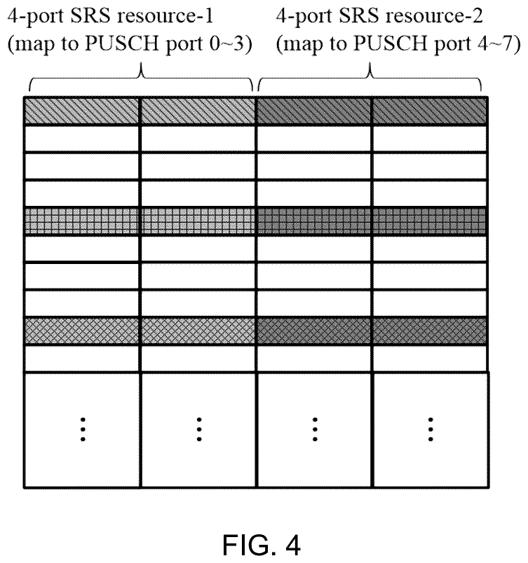

Examples of Cases 1-4, in the case of supporting 8-SRS ports in an 8-Tx UL operation, are shown in FIG. 4. The four cases correspond to CS value only, CS value and comb offset, CS value and time offset, and CS value and time-domain OCC, respectively.

### 5 Examples of SRS for Non-Codebook-Based PUSCH Transmissions

For PUSCH non-codebook transmissions, each SRS resource comprises a single SRS port, and for supporting massive UL transmitters, sufficient SRS resources are introduced in any given SRS resource sets. However, for these non-codebook transmissions, the UE is configured to calculate the precoder or beam state used for the transmission of SRS based on measurements from an associated CSI-RS resource.

In some embodiments, the UE can be configured with one or more SRS resource sets, and each of SRS resource sets can be configured with one or more CSI-RS resources that are used for determining the precoder or beam state used for the SRS transmission.
For example, the one or more CSI-RS resources can be configured to have the same number of CSI-RS ports, the same power, or the same power offset (e.g., powerControlOffsetSS, or being compared with SSB).
For example, the one or more CSI-RS resources can be associated with a same triggering state or have a same triggering offset.
For example, the one or more CSI-RS resources can be associated with individual triggering offsets or are from different CSI-RS resource sets.
For example, the UE can calculate the precoding used for the SRS transmission in an SRS resource set based on one or more CSI-RS resources, and then the SRS resource set can be associated with more than one UL power control parameter (e.g., 2 path-loss RSs).
For example, the one or more SRS resource set can be associated with the same CSI-RS or a single CSI-RS, e.g., as in the single-TRP case but for supporting massive UL transmissions.

In some embodiments, the UE can be configured with one or more SRS resource sets, and each of the SRS resource set(can be configured with a single CSI-RS resource for determining the precoder or beam state used for the SRS transmission, and then the CSI-RS resource can be associated with more than one TCI state.
For example, there may be one or more CSI-RS port groups in the CSI-RS resource, and then each of the CSI-RS port groups can be associated with one or more of the more than one TCI state.
For example, the CSI-RS can have more than one port group, and each port group can be configured with one TCI state (which corresponds to individual TRP/panel in coherent-joint transmission (C-JT)). Then, for SRS for non-codebook transmissions, the UE can be configured to calculate the precoder based on the CSI-RS for SRS transmissions targeted to multiple TRP in C-JT.

In some embodiments, for coherent-JT, multiple SRS resource sets for codebook and non-codebook PUSCH can be associated with the same UL power control parameter, which ensures that the same UL Tx power is used for each SRS.
For example, the power control adjustment state (e.g., closed loop value) can be updated at the beginning of first SRS resource per the SRS resource set.
For example, the power control adjustment state (e.g., closed loop value) can be updated at the beginning of first SRS resource for all of the SRS resource sets.

### 6 Examples of SRS for PUSCH Transmissions

A PUSCH transmission (e.g., either codebook-based PUSCH or non-codebook based PUSCH) may correspond to one or more SRS resources (e.g., a codepoint for SRS resource indicator (SRI) in the DCI field refers to two SRS resources), and PUSCH using the same SRS ports in one or more SRS resources is transmitted.

In some embodiments, the mapping between PUSCH port and SRS port (e.g., the renumbered index for the SRS port aligning with the PUSCH port index) is determined based on an index of the SRS port in the corresponding SRS resource, the parity of the index of SRS port (e.g., whether it is even or odd), or the index of the corresponding SRS resource (e.g., the corresponding index in the one or more SRS resources).
For example, for the i-th SRS port in the (j+1)-th SRS resource (e.g., when SRS ports are numbered from 0, and SRS resources are numbered from 1), the mapped PUSCH port is determined as (i+j×N), where N is the number of SRS ports in an SRS resource. In the case that there are two SRS resources, and each having four ports, e.g., port-{ a₁, b₁, c₁, d₁} for the first SRS resource and port-{a₂, b₂, c₂, d₂} for the second SRS resource, then the indices for port-{a₁, b₁, c₁, d₁, a₂, b₂, c₂, d₂} correspond to 1000+{0, 1, 2, 3, 4, 5, 6, 7}.
For example, for the i-th SRS port in the (j+1)-th SRS resource (e.g., when SRS ports are numbered from 0, and SRS resources are numbered from 1), the mapped PUSCH port is determined as (i+sum(j)), where sum(j) is the total number of SRS ports across the lowest indexed (j−1)-th SRS resources, and where sum(0)=0.
For example, the index for SRS resource in the one or more SRS resource is numbered by MAC-CE or RRC (e.g., for a codepoint) or numbered in ascending order by SRS resource index or the corresponding SRS resource set index (e.g., 0 for the lowest SRS resource index, 1 for the second lowest SRS resource index, etc.)

In some embodiments, the one or more SRS resources are in the same SRS resource set or the same SRS resource sub-set. In an example, in an SRS resource set, the SRS resource subsets (e.g., also called an SRS resource pair) can be configured, and SRS resource subsets and SRS resources (that do not belong to the subsets) can be grouped in a single set.

In some embodiments, the one or more SRS resources are from different SRS resource sets. In these embodiments, each of the one or more SRS resources can be associated with a different closed loop for PUSCH.

In some embodiments, the SRS ports from each of the one or more SRS resources are associated with different UE antenna ports.

In some embodiments, the one or more SRS resources can be associated with different closed loops for PUSCH (e.g., different power control adjustment states for PUSCH).

In some embodiments, one codepoint in SRI field in the DCI can be associated with a pair of SRS resources. In an example, the association can be configured and/or activated by MAC-CE or RRC. In another example, the SRS resources for each pair should correspond to different SRS resource set or sub-set. In yet another example, if only one pair of SRS resources is activated or configured, the SRS resources in the pair is applied directly (e.g., the subsequent DCI indication is not needed).

In some embodiments, at least one of the following features is implemented:
The one or more SRS resources are located in the same OFDM symbol (e.g., with the same transmission comb number K_{TC} (e.g., comb-4) but with different a comb-offset or a different cyclic-shift (CS) value;
There is no time domain gap between neighboring SRS resources;
There are no downlink symbols or a downlink signal between two SRS resources within a period; or
The power control adjustment state (e.g., closed loop value) is updated at the beginning of first SRS resource in the SRS resource set.

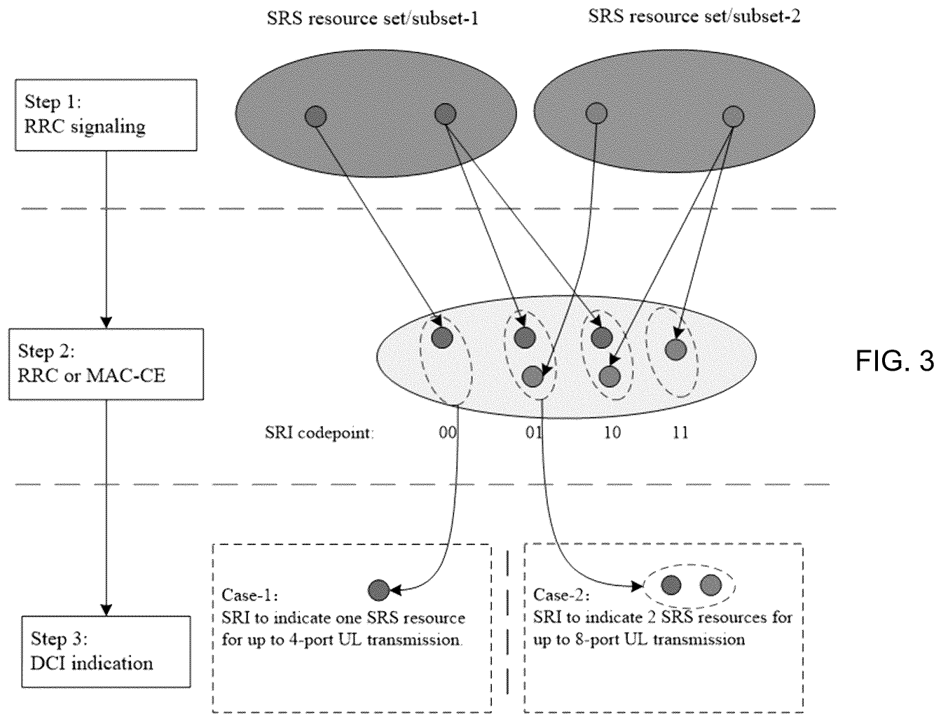

In some embodiments, and as shown in FIG. 3, the one or more SRS resources can be associated with an SRI codepoint in the DCI. As shown therein, in the RRC, there are multiple SRS resource sets/subsets configured by gNB (e.g., Step 1 in FIG. 3), and then in MAC-CE or RRC level, the one or more SRS resources can be associated with one SRS codepoint (e.g., Step 2 in FIG. 3) for DCI indication (e.g., Step 3 in FIG. 3). In an example, for 8-TX UL operation, there are two SRS resource sets/subsets, and in each of SRS resource sets/subsets, there is only one 4-port SRS resource in a set.

In some embodiments, and as shown in FIG. 4, two SRS resources (each of which has 4-port) can be transmitted for an 8-Tx PUSCH transmission. As shown therein, the 4 ports in the first SRS resource correspond to PUSCH port 0˜3 (or 1000˜1003) and the 4 ports in the second SRS resource correspond to PUSCH 4˜7 (or 1004˜1007). As shown in this example, there is no time-domain gap between the two SRS resources because the two SRS resources correspond to different transmitters (or Tx chains), and thus, the time-domain gap is not needed. In some embodiments, the one or more PUSCH ports comprises one or more PUSCH port groups, and one of the one or more PUSCH port groups is mapped to SRS ports in one respective resource of the one or more SRS resources in an order (c.g., ascending, descending, etc.).

### 7 Examples of SRS for Antenna Switching

For supporting massive UL transmitters, more SRS ports and SRS resources can be configured for antenna switching (also called as downlink (DL) channel state information (CSI) acquisition), e.g., 8-transmitters and 8-receivers (8T8R). The different SRS antenna ports can be allocated across different SRS resources, which can be in a single SRS resource set or different SRS resource sets.
For example, the UE can be configured with one or more SRS resource sets, e.g., up to 2 SRS resource sets. Each of the SRS resource sets includes one SRS resource, and there are 8 SRS ports for each SRS resource. In these implementations, a single SRS resource is sufficient for supporting the antenna switching procedure in 8T8R. The multiple SRS resource sets can refer to different time-domain behaviors, e.g., one SRS resource set used for periodic transmissions, and the other SRS resource set used for aperiodic transmissions.
For example, the UE can be configured with one or more SRS resource sets, each SRS resource set having two SRS resources, each SRS resource having 4 SRS ports, and the SRS port of each SRS resource in a given set being associated with a different UE antenna port. In these implementations, two SRS resources in an SRS resource set are needed for supporting the antenna switching procedure (also called as downlink (DL) channel state information (CSI) acquisition) in 8T8R. Furthermore, in a given time unit, the two SRS resources in the set can be transmitted simultaneously.
For example, the UE can be configured with up to two SRS resource sets, with each SRS resource in the two SRS resource sets having an SRS port that is associated with a different UE antenna port. E.g., the UE can be configured with {0, 2, 4, 6}-port for an SRS resource in the first SRS resource set, and with {1, 3, 4, 7}-port for an SRS resource in the second SRS resource set.
For example, for 8T8R, configuring more than one SRS resource set for antenna switching (e.g., configured with higher layer parameter usage set as ‘antennaSwitching’) or triggering the more than one SRS resource set in the same time unit (e.g., symbol or slot) is precluded.

### 8 Examples of Port-Level Hopping and Beamformed SRS

The disclosed embodiments are configured to support massive UL transmitters, which can be used to perform high-resolution beamforming compared with legacy UE in C-JT. In order to mitigate the UL interference and implicitly represent DL interference, the implementations described herein support SRS port hopping and beamformed SRS (with assistance of DL RS, e.g., CSI-RS, non-zero-power (NZP) channel state information (CSI)-reference signal (RS) for interference measurement, and CSI interference measurement (CSI-IM)).

In some embodiments, for SRS port level hopping, the CS value and the comb offset corresponding to an SRS port can be determined based on a time unit associated with the SRS.
For example, the time unit includes at least one of an SRS counter that indicates an index associated with a transmission of the SRS, a number of slots, a symbol index of a symbol associated with the SRS, or a number of symbols associated with the SRS.
For example, one or more of the following can also be determined based on the time unit:
   {CS value, initialization value for the SRS (e.g., cᵢₙᵢₜ, u, or v) }, {CS value, an offset for initialization value for the SRS}, or {CS value, a partial frequency scaling factor}; or
   {comb offset, initialization value for the SRS}, {comb offset, an offset for initialization value for the SRS}, or {comb offset, a partial frequency scaling factor}; or
   {CS value, comb offset, initialization value for the SRS}, {CS value, comb offset, an offset for initialization value for the SRS}, or {CS value, comb offset, a partial frequency scaling factor}.

In some embodiments, for beamformed SRS, the precoder or beam state of the SRS transmission is based on a reference signal (RS) for interference measurement, CSI-IM, or a RS for channel measurement (c.g., SSB or CSI-RS).
For example, a measurement on the RS for interference measurement and CSI-IM can be assumed to be interference or an interference layer. Thus, for the SRS precoder, the UL precoder should mitigate the impacts from interference emulated by the RS for interference measurement and CSI-IM.
For example, the RS for interference measurement comprises non-zero-power (NZP) channel state information (CSI)-reference signal (RS) for interference measurement.
For example, the SRS can implicitly reflect the DL interference spatial information while exploiting UL-DL reciprocity.

### 9 Example Embodiments and Implementations of the Disclosed Technology

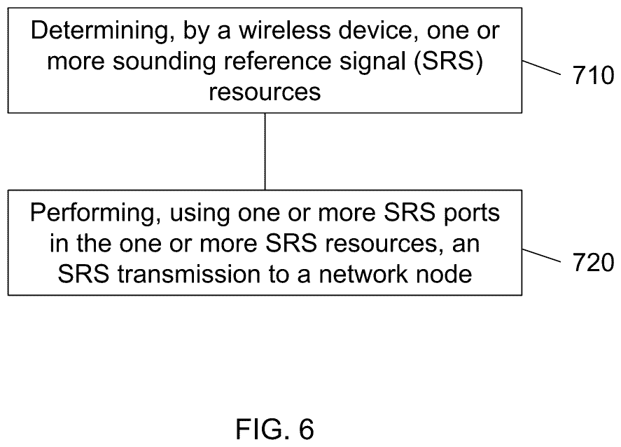

FIG. 6 shows a flowchart for an example method 600 for wireless communication. As shown therein, the method 600 includes, at operation 610, determining, by a wireless device, one or more sounding reference signal (SRS) resources.

The method 600 includes, at operation 620, performing, using one or more SRS ports in the one or more SRS resources, an SRS transmission to a network node.

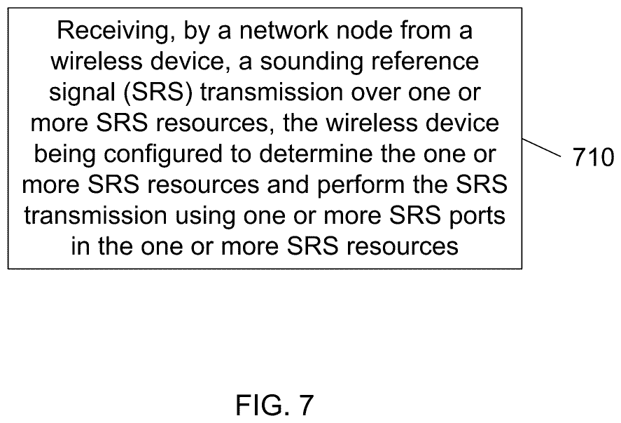

FIG. 7 shows a flowchart for another example method 700 for wireless communication. A shown therein, the method 700 includes, at operation 710, receiving, by a network node from a wireless device, a sounding reference signal (SRS) transmission over one or more SRS resources, the wireless device being configured to determine the one or more SRS resources and perform the SRS transmission using one or more SRS ports in the one or more SRS resources.

Embodiments of the disclosed technology provide, inter alia, the following technical solutions:
1. A method for wireless communication, including determining, by a wireless device, one or more sounding reference signal (SRS) resources, and performing, using one or more SRS ports in the one or more SRS resources, an SRS transmission to a network node.
2. A method for wireless communication, including receiving, by a network node from a wireless device, a sounding reference signal (SRS) transmission over one or more SRS resources, wherein the wireless device is configured to determine the one or more SRS resources and perform the SRS transmission using one or more SRS ports in the one or more SRS resources.
3. The method of solution 1 or 2 (e.g., as discussed in Section 6), wherein a physical uplink shared channel (PUSCH) transmission corresponds to the one or more SRS resources, and wherein the PUSCH transmission is performed using one or more PUSCH ports.
4. The method of solution 3, wherein at least one of the one or more PUSCH ports includes one or more PUSCH port groups, wherein one of the one or more PUSCH port groups is mapped to one of the one or more SRS ports in one respective resource of the one or more SRS resources by order, or a mapping between the one or more PUSCH ports and the one or more SRS ports is based on an index of a SRS port in the corresponding SRS resource, an index of the corresponding SRS resource, or a parity of the index of the SRS port.

15. The method of solution 4, wherein an i-th SRS port in a (j+1)-th SRS resource is mapped to a (i+j×N)-th PUSCH port, wherein N is an integer that denotes a number of SRS ports in an SRS resource.
6. The method of solution 4, wherein an i-th SRS port in a (j+1)-th SRS resource is mapped to a (i+sum(j))-th PUSCH port, wherein sum(M) denotes a total number of SRS ports in a lowest indexed (M−1) SRS resources, and wherein M is an integer.
7. The method of solution 4, wherein an index of the i-th SRS port in the (j+1)-th SRS resource or a starting index of the i-th SRS port in the (j+1)-th SRS resource is based on a medium access control (MAC)-control element (CE) or a radio resource control (RRC).
8. The method of solution 3, wherein the one or more SRS resources are in a same SRS resource set or a same SRS resource subset.
9. The method of solution 3, wherein at least one of the at least two of the one or more SRS resources are from different SRS resource sets, an SRS port from each of the one or more SRS resources is associated with a different antenna port of the wireless device, each of the one or more SRS resources is associated with a different power control adjustment state for the PUSCH, the one or more SRS resources are located in a same orthogonal frequency division multiplexing (OFDM) symbol, or the one or more SRS resources correspond to a same transmission comb number.
10. The method of solution 3, wherein at least a combination of the one or more SRS resources is associated with a codepoint in an SRS resource indicator (SRI) field in a downlink control information (DCI).
11. The method of solution 10, wherein the association between the combination of the one or more SRS resources and the codepoint is activated or configured by a medium access control (MAC) control element (CE) or a radio resource control (RRC).
12. The method of solution 10, wherein at least one of each SRS resource in the combination of the one or more SRS resources corresponds to a different SRS resource set or SRS resource subset, or at least one SRS resource in the combination of the one or more SRS resources is applied to the PUSCH transmission in response to only one combination being activated or configured by the MAC-CE or the RRC.
13. The method of solution 3, wherein a first SRS resource of the one or more SRS resources has a first comb offset and a second SRS resource of the one or more SRS resources has a second comb offset different from the first comb offset.
14. The method of solution 3, wherein a first SRS resource of the one or more SRS resources has a first cyclic-shift (CS) value and a second SRS resource of the one or more SRS resources has a second CS value different from the first CS value.
15. The method of solution 3, wherein at least one of a time-domain gap is excluded between two SRS resources of the one or more SRS resources, the time-domain gap is excluded between two SRS resources in one or more SRS resource sets including at least one of the one or more SRS resources, a downlink symbol or a downlink signal is excluded between two SRS resources of the one or more SRS resources, the downlink symbol or the downlink signal is excluded between two SRS resources in one or more SRS resource sets including at least one of the one or more SRS resources, the one or more SRS resources are associated with a same uplink power control parameter, a power control adjustment state is updated at a beginning of a first SRS resource of the one or more SRS resources, or the power control adjustment state is updated at a beginning of a first SRS resource in one or more SRS resource sets including at least one of the one or more SRS resources.
16. The method of solution 1 or 2 (e.g., as discussed in Section 4), wherein the one or more SRS resources includes a single SRS resource, and wherein a codebook-based physical uplink shared channel (PUSCH) transmission corresponds to the single SRS resource.
17. The method of solution 16, wherein the one or more SRS ports is determined based on a cyclic-shift (CS) value or a comb offset.
18. The method of solution 17, wherein at least one of the one or more SRS ports in the single SRS resource is determined based only on the CS value, and wherein a transmission comb number is 2 or 4, the one or more SRS ports in the single SRS resource is determined based on the CS value and the comb offset, and wherein the transmission comb number is 2, 4, or 8, the one or more SRS ports in the single SRS resource is determined based on the CS value and a time offset, and wherein the transmission comb number is 2, 4, or 8, the one or more SRS ports in the single SRS resource is determined based on the CS value and an orthogonal cover code (OCC) parameter, and wherein the transmission comb number is 2, 4, or 8, or the one or more SRS ports in the single SRS resource is determined based on the CS value, the comb offset, and the OCC parameter, and wherein the transmission comb number is 2, 4, or 8.
19. The method of solution 16, wherein the i-th CS value (αᵢ) for an i-th SRS port (pᵢ) of the single SRS resource is determined as

$${α}_{i} = 2 π \frac{{n}_{SRS}^{cs , i}}{{n}_{SRS}^{cs , max}} ,$$

wherein

$${n}_{SRS}^{cs , i} = ( {n}_{SRS}^{cs} + \frac{{n}_{SRS}^{cs , max} ⌊ ( {p}_{i} - 1000 ) / 2 ⌋}{{N}_{ap}^{SRS} / 2} )$$

mod n_{SRS}^{cs,max}, wherein n_{SRS}^{cs,max} is a maximum number of cyclic shifts, wherein n_{SRS}^{cs} is a cyclic shift parameter corresponding to the single SRS resource, and wherein Nₐₚ^{SRS} is a number of antenna ports.
20. The method of solution 19, wherein at least one of Nₐₚ^{SRS}=8, Nₐₚ^{SRS}=8 and n_{SRS}^{cs,max}=6, or Nₐₚ^{SRS}=8 and K_{TC}=8.
21. The method of solution 16, wherein the i-th CS value (αᵢ) for an i-th SRS port (pᵢ) of the single SRS resource is determined as (pᵢ mod Nₐₚ^{SRS}) or (floor(pᵢ/2)), wherein Nₐₚ^{SRS} is a number of antenna ports.
22. The method of solution 16, wherein the i-th comb offset (k_{TC}^{(p}^{ᵢ}⁾) for an i-th SRS port (pᵢ) is determined as (k_{TC}^{(p}^{ᵢ}⁾=(k̅_{TC}+K_{TC}/2) mod K_{TC}) in response to a condition, wherein k_{TC}^{(p}^{ᵢ}⁾=k̅_{TC} otherwise, wherein k̅_{TC} is the comb offset, and K_{TC} is a transmission comb number.
23. The method of solution 22, wherein the condition includes at least one of Nₐₚ^{SRS}=8, pᵢ∈{1001, 1003, 1005, 1007}, n_{SRS}^{cs,max}=6, or K_{TC}=8, wherein Nₐₚ^{SRS} is a number of antenna ports of the wireless device, wherein n_{SRS}^{cs,max} is a maximum number of cyclic shifts, and wherein n_{SRS}^{cs,max} is a maximum number of cyclic shifts.
24. The method of solution 16, wherein the i-th comb offset (k_{TC}^{(p}^{ᵢ}⁾) for an i-th SRS port (pᵢ) is determined as k̅_{TC} or (k̅_{TC}+K_{TC}/2) mod K_{TC} wherein k̅_{TC} is the comb offset, and K_{TC} is a transmission comb number.
25. The method of solution 16, wherein at least one of the single SRS resource includes 8 SRS ports, each of which can be identified according to both 4 individual CS values and 2 individual OCC parameters, the single SRS resource includes 8 SRS ports, each of which can be identified according to both 2 individual CS values and 4 individual OCC parameters, or the time offset is determined according to the transmission comb number K_{TC}.
26. The method of solution 1 or 2, wherein at least one of a comb offset for an SRS port group in an SRS resource of the one or more SRS resources is configured by a medium access control (MAC) control element (CE) or a radio resource control (RRC), or a combination of a cyclic shift value and the comb offset for the SRS port group in the SRS resource of the one or more SRS resources is configured by the MAC-CE or the RRC.
27. The method of solution 1 or 2 (e.g., as discussed in Section 5), wherein a non-codebook physical uplink shared channel (PUSCH) transmission corresponds to the one or more SRS resources, and wherein the one or more SRS resources are part of one or more SRS resource sets.
28. The method of solution 27, wherein each of the one or more SRS resource sets is configured with one or more channel state information reference signal (CSI-RS) resources that are used to determine a precoder or a beam state for the SRS transmission.
29. The method of solution 28, wherein at least one of each of the one or more CSI-RS resources includes an equal number of CSI-RS ports, an equal power, or an equal power offset, the one or more CSI-RS resources is associated with a same triggering state or a same triggering offset, or each of the one or more CSI-RS resources is associated with a respective triggering offset or is from a different CSI-RS resource set.
30. The method of solution 27, wherein each of the one or more SRS resource sets is configured with a single channel state information reference signal (CSI-RS) resource that is used to determine a precoder or a beam state for the SRS transmission, and wherein the single CSI-RS resource is associated with more than one transmission configuration indicator (TCI) states.
31. The method of solution 30, wherein the single CSI-RS resource includes one or more CSI-RS port groups, and wherein each of the one or more CSI-RS port groups is associated with one or more of the more than one TCI states.
32. The method of solution 1 or 2 (e.g., as discussed in Section 7), wherein the SRS transmission is used for downlink (DL) channel state information (CSI) acquisition, antenna switching, or a mode with 8-transmitter and 8-receiver (8T8R).
33. The method of solution 32, wherein each of the one or more SRS resources is in a different SRS resource set, and wherein a number of the one or more SRS ports in each SRS resource is equal to 8.
34. The method of solution 32, wherein the one or more SRS resources include two SRS resources, where the two SRS resources are in an SRS resource set, wherein a number of the one or more SRS ports in each of the two SRS resources is equal to 4, and wherein the SRS ports of the two SRS resources are associated with a different antenna port of the wireless device.
35. The method of solution 32, wherein the one or more SRS resources are in one or more SRS resource sets, wherein the one or more SRS resource sets include up to two SRS resource sets, and wherein each of the one or more SRS ports in the one or more SRS resources is associated with a different antenna port of the wireless device.
36. The method of solution 32, wherein only one of the one or more SRS resource sets can be configured or triggered for antenna switching in a single time unit.
37. The method of solution 1 or 2 (e.g., as discussed in Section 8), wherein at least one of a cyclic-shift (CS) value or a comb offset corresponding to one of the one or more SRS ports is determined based on a time unit associated with the SRS transmission.
38. The method of solution 37, wherein the time unit associated with the SRS includes at least one of a counter that indicates an index associated with the SRS transmission, a number of slots, a symbol index of a symbol associated with the SRS transmission, or a number of symbols associated with the SRS transmission.
39. The method of solution 37, wherein at least one of an initialization value for the SRS transmission, an offset for the initialization value, or a partial frequency scaling factor is determined based on the time unit associated with the SRS transmission.
40. The method of solution 1 or 2, wherein a precoder or a beam state for the SRS transmission is based on a reference signal for an interference measurement or a channel state information (CSI)-interference measurement (IM).
41. The method of solution 40, wherein a measurement on the reference signal for the interference measurement or the CSI-IM corresponds to an interference or an interference layer.
42. An apparatus for wireless communication including a processor, configured to implement a method recited in one or more of solutions 1 to 41.
43. A non-transitory computer readable program storage medium having code stored thereon, the code, when executed by a processor, causing the processor to implement a method recited in one or more of solutions 1 to 41.

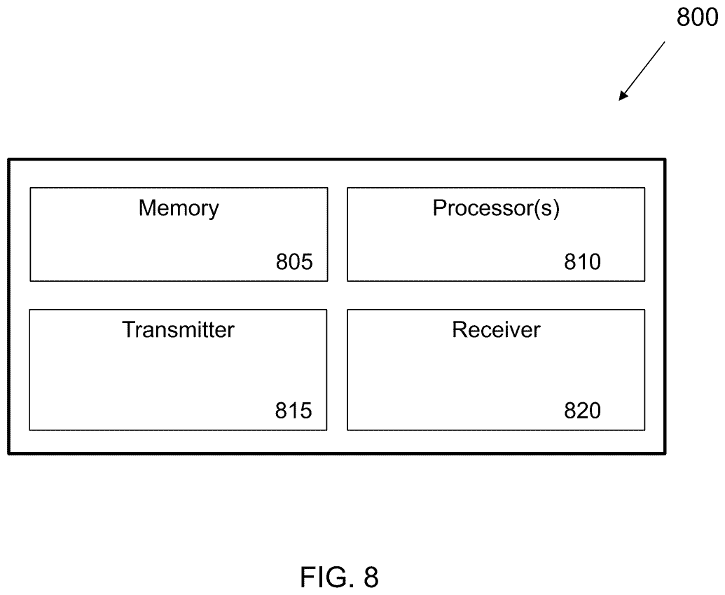

FIG. 8 shows an example block diagram of a hardware platform 800 that may be a part of a network device (e.g., base station) or a communication device (e.g., a user equipment (UE)). The hardware platform 800 includes at least one processor 810 and a memory 805 having instructions stored thereupon. The instructions upon execution by the processor 810 configure the hardware platform 800 to perform the operations described in FIGS. 6 and 7 and in the various embodiments described in this patent document. The transmitter 815 transmits or sends information or data to another device. For example, a network device transmitter can send a message to a user equipment. The receiver 820 receives information or data transmitted or sent by another device. For example, a user equipment can receive a message from a network device.

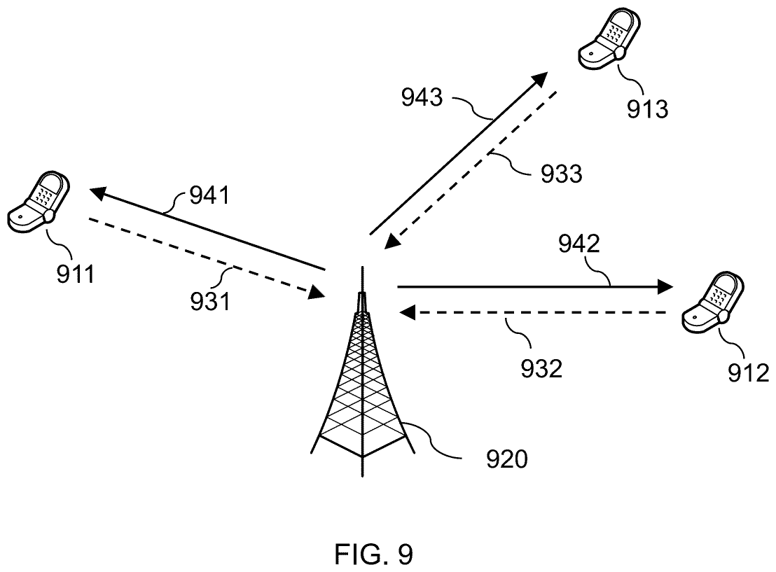

The implementations as discussed above will apply to a wireless communication. FIG. 9 shows an example of a wireless communication system (e.g., a 5G or NR cellular network) that includes a base station 920 and one or more user equipment (UE) 911, 912 and 913. In some embodiments, the UEs access the BS (e.g., the network) using a communication link to the network (sometimes called uplink direction, as depicted by dashed arrows 931, 932, 933), which then enables subsequent communication (e.g., shown in the direction from the network to the UEs, sometimes called downlink direction, shown by arrows 941, 942, 943) from the BS to the UEs. In some embodiments, the BS send information to the UEs (sometimes called downlink direction, as depicted by arrows 941, 942, 943), which then enables subsequent communication (e.g., shown in the direction from the UEs to the BS, sometimes called uplink direction, shown by dashed arrows 931, 932, 933) from the UEs to the BS. The UE may be, for example, a smartphone, a tablet, a mobile computer, a machine to machine (M2M) device, an Internet of Things (IOT) device, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations. enhancements and variations can be made based on what is described and illustrated in this disclosure.

1-43. (canceled)

44. A method for wireless communication, comprising:
determining, by a wireless device, one or more sounding reference signal (SRS) resources; and
performing, using one or more SRS ports in the one or more SRS resources, an SRS transmission to a network node,
wherein a codebook-based physical uplink shared channel (PUSCH) transmission corresponds to a single SRS resource of the one or more SRS resources,
wherein the one or more SRS ports in the single SRS resource is determined based on a cyclic-shift (CS) value and a comb offset,
wherein an i-th comb offset (k_{TC}^{(p}^{ᵢ}⁾ for an i-th SRS port (pᵢ) is determined as (k_{TC}^{(p}^{ᵢ}⁾=(k̅_{TC}+K_{TC}/2) mod K_{TC}) in response to a condition, wherein k_{TC}^{(p}^{ᵢ}⁾=k̅_{TC} otherwise, wherein k̅_{TC} is the comb offset, and K_{TC}=2, 4, or 8, is a transmission comb number,
wherein the condition comprises Nₐₚ^{SRS}=8 and pᵢ∈{1001, 1003, 1005, 1007}, and wherein Nₐₚ^{SRS} is a number of antenna ports of the wireless device.

45. The method of claim 44, wherein a physical uplink shared channel (PUSCH) transmission corresponds to the one or more SRS resources, and wherein the PUSCH transmission is performed using one or more PUSCH ports.

46. The method of claim 45, wherein at least one of:
each of the one or more SRS resources is associated with a different power control adjustment state for the PUSCH; or
the one or more SRS resources correspond to a same transmission comb number.

47. The method of claim 44, wherein a time offset is determined according to the transmission comb number K_{TC}.

48. The method of claim 44, wherein at least one of the cyclic-shift (CS) value or the comb offset corresponding to one of the one or more SRS ports is determined based on a time unit associated with the SRS transmission.

49. The method of claim 48, wherein the time unit associated with the SRS comprises at least one of a counter that indicates an index associated with the SRS transmission, a number of slots, a symbol index of a symbol associated with the SRS transmission, or a number of symbols associated with the SRS transmission.

50. An apparatus for communication, comprising:
at least one processor configured to:
determine, by a wireless device, one or more sounding reference signal (SRS) resources; and
perform, using one or more SRS ports in the one or more SRS resources, an SRS transmission to a network node,
wherein a codebook-based physical uplink shared channel (PUSCH) transmission corresponds to a single SRS resource of the one or more SRS resources,
wherein the one or more SRS ports in the single SRS resource is determined based on a cyclic-shift (CS) value and a comb offset,
wherein an i-th comb offset (k_{TC}^{(p}^{ᵢ}⁾ for an i-th SRS port (pᵢ) is determined as (k_{TC}^{(p}^{ᵢ}⁾=(k̅_{TC}+K_{TC}/2) mod K_{TC}) in response to a condition, wherein k_{TC}^{(p}^{ᵢ}⁾=k̅_{TC} otherwise, wherein k̅_{TC} is the comb offset, and K_{TC}=2, 4, or 8, is a transmission comb number,
wherein the condition comprises Nₐₚ^{SRS}=8 and pᵢ∈{1001, 1003, 1005, 1007}, and wherein Nₐₚ^{SRS} is a number of antenna ports of the wireless device.

51. The apparatus of claim 50, wherein a physical uplink shared channel (PUSCH) transmission corresponds to the one or more SRS resources, and wherein the PUSCH transmission is performed using one or more PUSCH ports.

52. The apparatus of claim 51, wherein at least one of:
each of the one or more SRS resources is associated with a different power control adjustment state for the PUSCH; or
the one or more SRS resources correspond to a same transmission comb number.

53. The apparatus of claim 50, wherein a time offset is determined according to the transmission comb number K_{TC}.

54. The apparatus of claim 50, wherein at least one of the cyclic-shift (CS) value or the comb offset corresponding to one of the one or more SRS ports is determined based on a time unit associated with the SRS transmission.

55. The apparatus of claim 54, wherein the time unit associated with the SRS comprises at least one of a counter that indicates an index associated with the SRS transmission, a number of slots, a symbol index of a symbol associated with the SRS transmission, or a number of symbols associated with the SRS transmission.

56. A method for wireless communication, comprising:
receiving, by a network node from a wireless device, a sounding reference signal (SRS) transmission over one or more SRS resources,
wherein the wireless device is configured to determine the one or more SRS resources and perform the SRS transmission using one or more SRS ports in the one or more SRS resources,
wherein a codebook-based physical uplink shared channel (PUSCH) transmission corresponds to a single SRS resource of the one or more SRS resources,
wherein the one or more SRS ports in the single SRS resource is determined based on a cyclic-shift (CS) value and a comb offset,
wherein an i-th comb offset (k_{TC}^{(p}^{ᵢ}⁾) for an i-th SRS port (pᵢ) is determined as (k_{TC}^{(p}^{ᵢ}⁾=(k̅_{TC}+K_{TC}/2) mod K_{TC}) in response to a condition, wherein k_{TC}^{(p}^{ᵢ}⁾=k̅_{TC} otherwise, wherein k̅_{TC} is the comb offset, and K_{TC}=2, 4, or 8, is a transmission comb number,
wherein the condition comprises Nₐₚ^{SRS}=8 and pᵢ∈{1001, 1003, 1005, 1007}, and wherein Nₐₚ^{SRS} is a number of antenna ports of the wireless device.

57. The method of claim 56, wherein a physical uplink shared channel (PUSCH) transmission corresponds to the one or more SRS resources, and wherein the PUSCH transmission is performed using one or more PUSCH ports, and
wherein at least one of:
each of the one or more SRS resources is associated with a different power control adjustment state for the PUSCH; or
the one or more SRS resources correspond to a same transmission comb number.

58. The method of claim 56, wherein a time offset is determined according to the transmission comb number K_{TC}.

59. The method of claim 56, wherein at least one of the cyclic-shift (CS) value or the comb offset corresponding to one of the one or more SRS ports is determined based on a time unit associated with the SRS transmission, and wherein the time unit associated with the SRS comprises at least one of a counter that indicates an index associated with the SRS transmission, a number of slots, a symbol index of a symbol associated with the SRS transmission, or a number of symbols associated with the SRS transmission.

60. An apparatus for communication, comprising:
at least one processor configured to:
receive, by a network node from a wireless device, a sounding reference signal (SRS) transmission over one or more SRS resources,
wherein the wireless device is configured to determine the one or more SRS resources and perform the SRS transmission using one or more SRS ports in the one or more SRS resources,
wherein a codebook-based physical uplink shared channel (PUSCH) transmission corresponds to a single SRS resource of the one or more SRS resources,
wherein the one or more SRS ports in the single SRS resource is determined based on a cyclic-shift (CS) value and a comb offset,
wherein an i-th comb offset (k_{TC}^{(p}^{ᵢ}⁾) for an i-th SRS port (pᵢ) is determined as (k_{TC}^{(p}^{ᵢ}ⁱ)=(k̅_{TC}+K_{TC}/2) mod K_{TC}) in response to a condition, wherein k_{TC}^{(p}^{ᵢ}⁾=k̅_{TC} otherwise, wherein k̅_{TC} is the comb offset, and K_{TC}=2, 4, or 8, is a transmission comb number,
wherein the condition comprises Nₐₚ^{SRS}=8 and pᵢ∈{1001, 1003, 1005, 1007}, and wherein Nₐₚ^{SRS} is a number of antenna ports of the wireless device.

61. The apparatus of claim 60, wherein a physical uplink shared channel (PUSCH) transmission corresponds to the one or more SRS resources, and wherein the PUSCH transmission is performed using one or more PUSCH ports, and
wherein at least one of:
each of the one or more SRS resources is associated with a different power control adjustment state for the PUSCH; or
the one or more SRS resources correspond to a same transmission comb number.

62. The apparatus of claim 60, wherein a time offset is determined according to the transmission comb number K_{TC}.

63. The apparatus of claim 60, wherein at least one of the cyclic-shift (CS) value or the comb offset corresponding to one of the one or more SRS ports is determined based on a time unit associated with the SRS transmission, and wherein the time unit associated with the SRS comprises at least one of a counter that indicates an index associated with the SRS transmission, a number of slots, a symbol index of a symbol associated with the SRS transmission, or a number of symbols associated with the SRS transmission.
